(19) United States
(12) Patent Application Publication
(10) Pub. No.: US 2025/0103378 A1
(43) Pub. Date: Mar. 27, 2025

(54) IN-VEHICLE CONTROL DEVICE, CONTROL METHOD, AND COMPUTER PROGRAM

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Tadahiro TAKAZAWA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/729,226

(22) PCT Filed: Dec. 28, 2022
(86) PCT No.: PCT/JP2022/048612

§ 371 Date: Jul. 16, 2024

(30) Foreign Application Priority Data
Jan. 18, 2022 (JP) 2022-005674

(51) Int. Cl. G06F 9/455; B60W 50/06

(52) U.S. Cl. CPC G06F 9/45558; B60W 50/06; B60W 2050/065; G06F 2009/45595

(57) ABSTRACT

An in-vehicle control device includes a control unit, a storage unit, and a communication unit, and a management unit that generates a plurality of virtual machines by allocating the physical resources for each allocation time. A first virtual machine executes processing that cannot be carried over to the next cycle. A second virtual machine executes processing that can be carried over to the next cycle. The management unit executes a first change control for changing the allocation time of each of the first virtual machine and the second virtual machine. The first change control includes a control for acquiring a processing time of the first virtual machine in a first cycle, and a control for extending the allocation time of the first virtual machine and shortening the allocation time of the second virtual machine in a cycle, when a buffer time is lower than a first predetermined value.

### CROSS-REFERENCE TO RELATED APPLICATIONS

This application is the U.S. national stage of PCT/JP2022/048612 filed on Dec. 28, 2022, which claims priority of Japanese Patent Application No. JP 2022-005674 filed on Jan. 18, 2022, the contents of which are incorporated herein.

### TECHNICAL FIELD

The present disclosure relates to an in-vehicle control device, a control method, and a computer program.

### BACKGROUND

Heretofore, virtualization technology for configuring one computer to function like multiple computers is known. For example, JP 2021-60923A discloses a technology for using a hypervisor function to configure multiple VMs (Virtual Machines) in an ECU (Electronic Control Unit) installed in a vehicle.

In JP 2021-60923A, the VM configuring unit included in the ECU switches the VMs, based on an allocation time set for each VM. For example, 60 msec processing time is allocated to a body control VM, and thereafter 40 msec processing time is allocated to a multimedia VM.

Here, when the processing time of a VM exceeds the allocation time, excess processing is postponed to the next cycle, and processing delays can occur due to the accumulation of postponed processing. When the processing time of the body control VM exceeds the allocation time, the VM configuring unit of JP 2021-60923A adds the surplus time (time obtained by subtracting the processing time from the allocation time) of another VM having a lower priority than the body control VM to the allocation time of the body control VM. For example, if the multimedia VM has a surplus time of 15 msec for processing, the VM configuring unit shortens the allocation time of the multimedia VM to 25 msec and extends the allocation time of the body control VM to 75 msec. Processing delays are thereby suppressed with the technology of JP 2021-60923A.

For example, when a VM performs processing (real-time processing) that cannot be carried over to the next cycle, the allocation time of the VM may be set to a time obtained by adding a certain amount of buffer time to the anticipated processing time. When the processing time of such a VM exceeds the allocation time, the processing that has been executed up to that point may fail and require redoing at a subsequent time such as in the next cycle.

Since the technology of JP 2021-60923A does not take real-time processing into consideration, buffer time that needs to be secured could possibly be allotted to the allocation time of another VM, and there is a risk of processing failure occurring in the VM whose allocation time has been reduced (i.e., VM whose buffer time has decreased).

Here, when a VM communicates with a device (e.g., external device such as a sensor) other than the ECU in which that VM is configured, the processing time of the VM may temporarily increase due to factors such as the output of the external device temporarily becoming unstable. Since processing failure can occur in the VM when such an increase in processing time occurs, the functions of the ECU in which multiple VMs are configured could not be efficiently exhibited.

The present disclosure has been made in view of such circumstances, and an object thereof is to control an in-vehicle control device including a plurality of virtual machines to function more efficiently.

### SUMMARY

An in-vehicle control device of the present disclosure is an in-vehicle control device to be installed in a vehicle, including physical resources including a control unit, a storage unit, and a communication unit, and a management unit configured to generate a plurality of virtual machines by allocating the physical resources for each allocation time, the plurality of virtual machines including a first virtual machine configured to communicate with an external device provided outside the in-vehicle control device and execute processing not carriable over to a next cycle, and a second virtual machine configured to execute processing carriable over to the next cycle, the management unit executing a first change control for changing an allocation time of each of the first virtual machine and the second virtual machine, and the first change control including a control for acquiring a processing time of the first virtual machine in a first cycle, and a control for extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

A control method of the present disclosure is a control method for controlling an in-vehicle control device to be installed in a vehicle, including a generating step of generating a plurality of virtual machines by allocating, for each allocation time, physical resources including a control unit, a storage unit, and a communication unit, and a control step of changing an allocation time of each of a first virtual machine and a second virtual machine among the plurality of virtual machines, the first virtual machine being configured to communicate with an external device provided outside the in-vehicle control device and execute processing not carriable over to a next cycle, the second virtual machine being configured to execute processing carriable over to the next cycle, and the control step including an acquisition step of acquiring a processing time of the first virtual machine in a first cycle, and a change step of extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

A computer program of the present disclosure is a computer program for controlling an in-vehicle control device to be installed in a vehicle, the computer program causing a computer to execute a generating step of generating a plurality of virtual machines by allocating, for each allocation time, physical resources including a control unit, a storage unit, and a communication unit, and a control step of changing an allocation time of each of a first virtual machine and a second virtual machine among the plurality of virtual machines, the first virtual machine being configured to communicate with an external device provided outside the in-vehicle control device and execute processing not carriable over to a next cycle, the second virtual machine being configured to execute processing carriable over to the next cycle, and the control step including an acquisition step of acquiring a processing time of the first virtual machine in a first cycle, and a change step of extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

### Advantageous Effects

According to the present disclosure, an in-vehicle control device including a plurality of virtual machines can be controlled to function more efficiently.

### BRIEF DESCRIPTION OF DRAWINGS

FIG. 1 is a schematic diagram illustrating an in-vehicle control device and a peripheral configuration thereof according to a first embodiment.

FIG. 2 is a diagram for describing the problem to be solved by the first embodiment.

FIG. 3 is a flowchart illustrating a control method according to the first embodiment.

FIG. 4 is a diagram illustrating an update table according to the first embodiment.

FIG. 5 is a diagram for describing changing of allocation times according to the first embodiment.

FIG. 6 is a flowchart illustrating a control method according to a second embodiment.

FIG. 7 is a diagram for describing changing of allocation times according to the second embodiment.

FIG. 8 is a diagram for describing changing of allocation times according to the second embodiment.

FIG. 9 is a diagram for describing buffer time according to a modification.

### DETAILED DESCRIPTION OF PREFERRED EMBODIMENTS

Hereinafter, a summary of embodiments of the present disclosure will be enumerated and described.

An in-vehicle control device of the present disclosure is an in-vehicle control device to be installed in a vehicle, including physical resources including a control unit, a storage unit, and a communication unit, and a management unit configured to generate a plurality of virtual machines by allocating the physical resources for each allocation time, the plurality of virtual machines including a first virtual machine configured to communicate with an external device provided outside the in-vehicle control device and execute processing not carriable over to a next cycle, and a second virtual machine configured to execute processing carriable over to the next cycle, the management unit executing a first change control for changing an allocation time of each of the first virtual machine and the second virtual machine, and the first change control including a control for acquiring a processing time of the first virtual machine in a first cycle, and a control for extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

When the processing time of the first virtual machine temporarily increases, such as during a period in which the output of the external device becomes unstable due to a disturbance, the management unit suppresses processing failure of the first virtual machine by extending the allocation time of the first virtual machine. The in-vehicle control device can thereby be controlled to function efficiently.

The management unit may execute the first change control, when the number of communication retries to the external device by the first virtual machine increases.

By adopting such a configuration, the management unit executes the first change control when the processing time of the first virtual machine is expected to increase, thus enabling the control load of the management unit to be reduced.

The management unit may, after executing the first change control, further execute a second change control for changing the allocation time of each of the first virtual machine and the second virtual machine, and the second change control may include a control for acquiring a processing time of the first virtual machine in a second cycle after the first cycle, and a control for shortening the allocation time of the first virtual machine and extending the allocation time of the second virtual machine in a cycle after the second cycle, when a buffer time calculated based on the acquired processing time and the allocation time of the first virtual machine changed in the first change control or a rate of change of the buffer time exceeds a second predetermined value greater than the first predetermined value.

When the processing time of the first virtual machine decreases, the management unit shortens the buffer time of the first virtual machine by shortening the allocation time of the first virtual machine. The in-vehicle control device can thereby be controlled to function efficiently.

The management unit may execute the second change control, when the number of communication retries to the external device by the first virtual machine decreases.

By adopting such a configuration, the management unit executes the second change control when the processing time of the first virtual machine is expected to decrease, thus enabling the control load of the management unit to be reduced.

The management unit may further execute a third change control for extending the allocation time of the first virtual machine and shortening the allocation time of the second virtual machine, when a predetermined condition indicating deterioration of the external device is satisfied.

Even if the processing time of the first virtual machine becomes longer than the initial allocation time due to deterioration of the external device, the management unit is able to suppress processing failure of the first virtual machine, by determining that the external device has deteriorated based on the predetermined condition and extending the allocation time of the first virtual machine. By adopting such a configuration, processing by the first virtual machine can be continued even after long-term use, while keeping the buffer time of the first virtual machine from initially being set excessively long, thus enabling the in-vehicle control device to be controlled to function efficiently.

The storage unit may store a first allocation time and a second allocation time that is longer than the first allocation time, and the management unit may execute the first change control after the third change control, may, in the third change control, set the allocation time of the first virtual machine to the first allocation time, before the predetermined condition is satisfied, and set the allocation time of the first virtual machine to the second allocation time, when the predetermined condition is satisfied, and may, in the first change control, extend the allocation time of the first virtual machine from the second allocation time.

By adopting such a configuration, in a state in which the allocation time of the first virtual machine has been extended, as a result of the third change control, to the second allocation time which takes into account the increase in processing time due to aging deterioration of the external device, the second allocation time of the first virtual machine can be additionally extended, as a result of the first change control, by taking into account the temporary increase in processing time caused by factors such as a disturbance of the external device. The allocation time of the first virtual machine can thereby be set in accordance with the current situation, thus enabling the functions of the in-vehicle control device to be more efficiently exhibited.

The storage unit may store a table in which information relating to the predetermined condition is associated with allocation times of the first virtual machine including the first allocation time and the second allocation time, and the management unit may, in the third change control, extend the allocation time of the first virtual machine with reference to the table, when the predetermined condition is satisfied.

By storing the allocation times as a table in advance, the processing load for calculating the allocation time in the management unit can be reduced.

The predetermined condition may include a predetermined time or longer elapsing from a reference timepoint, the external device operating for a predetermined time or longer from the reference timepoint, or the vehicle traveling a predetermined distance or more from the reference timepoint, and the reference timepoint may include a timepoint at which use of the external device is started, or a timepoint at which the allocation time of the first virtual machine is extended.

By adopting such a configuration, the management unit is able to more easily determine that the external device has deteriorated.

A control method of the present disclosure is a control method for controlling an in-vehicle control device to be installed in a vehicle, including a generating step of generating a plurality of virtual machines by allocating, for each allocation time, physical resources including a control unit, a storage unit, and a communication unit, and a control step of changing an allocation time of each of a first virtual machine and a second virtual machine among the plurality of virtual machines, the first virtual machine being configured to communicate with an external device provided outside the in-vehicle control device and execute processing not carriable over to a next cycle, the second virtual machine being configured to execute processing carriable over to the next cycle, and the control step including an acquisition step of acquiring a processing time of the first virtual machine in a first cycle, and a change step of extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

By adopting such a configuration, when the processing time of the first virtual machine temporarily increases, such as during a period when the output of the external device becomes unstable due to a disturbance, the allocation time of the first virtual machine can be extended, and thus processing failure of the first virtual machine can be suppressed. The in-vehicle control device can thereby be controlled to function efficiently.

A computer program of the present disclosure is a computer program for controlling an in-vehicle control device to be installed in a vehicle, the computer program causing a computer to execute a generating step of generating a plurality of virtual machines by allocating, for each allocation time, physical resources including a control unit, a storage unit, and a communication unit, and a control step of changing an allocation time of each of a first virtual machine and a second virtual machine among the plurality of virtual machines, the first virtual machine being configured to communicate with an external device provided outside the in-vehicle control device and execute processing not carriable over to a next cycle, the second virtual machine being configured to execute processing carriable over to the next cycle, and the control step including an acquisition step of acquiring a processing time of the first virtual machine in a first cycle, and a change step of extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

By adopting such a configuration, when the processing time of the first virtual machine temporarily increases, such as during a period when the output of the external device becomes unstable due to a disturbance, the allocation time of the first virtual machine can be extended, and thus processing failure of the first virtual machine can be suppressed. The in-vehicle control device can thereby be controlled to function efficiently.

Hereinafter, embodiments of the present disclosure will be described in detail, with reference to the drawings.

### FIRST EMBODIMENT

### In-Vehicle Control Device and Peripheral Configuration Thereof

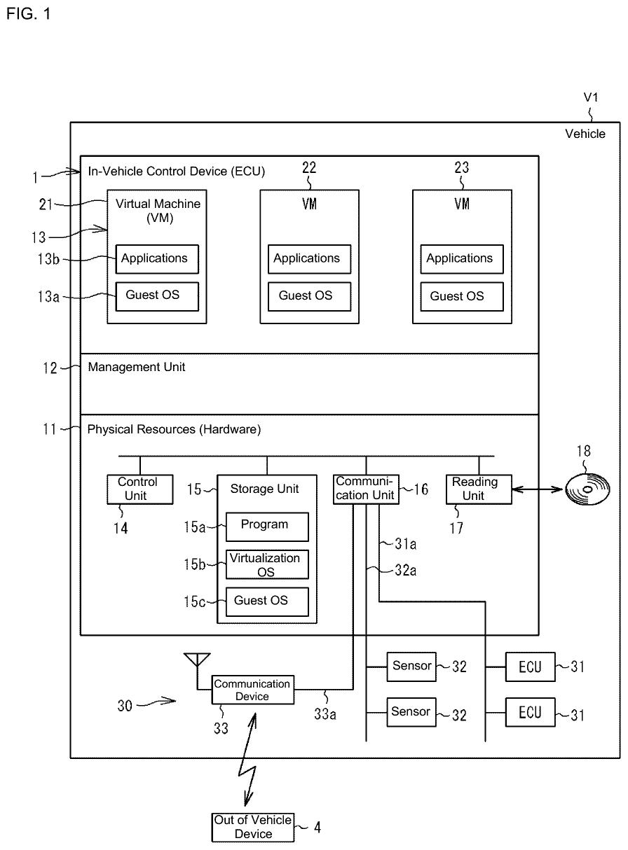

FIG. 1 is a schematic diagram illustrating an in-vehicle control device 1 according to a first embodiment and the peripheral configuration thereof.

The in-vehicle control device 1 is a device installed in a vehicle V1 and is also referred to as an ECU (Electronic Control Unit). The vehicle V1 is, for example, an automobile, but the type of vehicle V1 is not particularly limited. In addition to the in-vehicle control device 1, the vehicle V1 is equipped with a plurality of external devices 30. The plurality of external devices 30 include a plurality of ECUs 31, a plurality of sensors 32, and a plurality of communication devices 33.

The ECUs 31 are, for example, devices (operation-related ECUs) that control various parts (e.g., braking devices, doors, battery, air conditioner, etc.) of the vehicle V1. The functions of the ECUs 31 are not particularly limited, and the ECUs 31 may be devices (recognition-related ECUs) that communicate with the sensors 32 and monitor the state of various parts of the vehicle V1. The ECUs 31 are, for example, connected to a communication unit 16 described later via a communication line 31a.

The sensors 32 are, for example, LiDAR (Light Detection and Ranging) sensors for monitoring the surroundings of the vehicle V1. The sensors 32 are not particularly limited in terms of type and may be temperature sensors that detect the temperature in the vehicle V1, or motion sensors that detect that a person has boarded the vehicle V1. The sensors 32 are, for example, connected to the communication unit 16 described later via a communication line 32a.

The communication device 33 is, for example, a TCU (Telematics Communication Unit), and performs wireless communication with an out-of-vehicle device 4 via a network such as the Internet. The communication device 33 is, for example, connected to the communication unit 16 described later via a communication line 33a.

The out-of-vehicle device 4 is a device installed outside the vehicle V1. The out-of-vehicle device 4 is, for example, a server including a control unit, a storage unit, and a communication unit. The storage unit of the out-of-vehicle device 4 stores, for example, a program or data for controlling the in-vehicle control device 1 and the ECUs 31. For example, the manufacturer of the in-vehicle control device 1 or the ECUs 31 modifies a program or data as necessary and stores the modified program or data in the storage unit of the out-of-vehicle device 4 at any time. A communication unit of the out-of-vehicle device 4 transmits the modified program or data to the communication device 33 as updated data.

The in-vehicle control device 1 is an ECU that functions as a plurality of VMs (Virtual Machines) 13, using virtualization technology described later. That is, the in-vehicle control device 1 is an integrated ECU that functions as a plurality of virtual ECUs. The functions of each of the plurality of VMs 13 are not particularly limited. For example, the VMs 13 may be devices that relay update data that is input from the communication device 33 to the ECUs 31. In this case, in a network environment in which there are a plurality of different LANs (Local Area Networks) in the vehicle V1, such as a central gateway (CGW), for example, the VMs 13 may relay data that is transmitted or received by the ECUs 31 in the respective LANs. Also, similarly to the ECUs 31 described above, the VMs 13 may be devices that control various parts of the vehicle V1 or may be devices that monitor the state of various parts the vehicle V1.

### Internal Configuration of In-vehicle Control Device

The in-vehicle control device 1 is provided with various physical resources 11 and a management unit 12 that generates the plurality of VMs 13 by allocating the physical resources 11. The physical resources 11 include a control unit 14, a storage unit 15, the communication unit 16, and a reading unit 17. The control unit 14, the storage unit 15, the communication unit 16, and the reading unit 17 are electrically connected to each other by a bus, for example.

The control unit 14 is, for example, a CPU (Central Processing Unit). The control unit 14 may also be a GPU (Graphics Processing Unit) or an integrated circuit such as an FPGA (Field-Programmable Gate Array).

The storage unit 15 includes a volatile memory and a non-volatile memory and stores various data. The volatile memory is, for example, RAM (Random Access Memory). The non-volatile memory is, for example, flash memory, HDD (Hard Disk Drive), SSD (Solid State Drive) or ROM (Read Only Memory).

The storage unit 15 stores, in the non-volatile memory, a computer program 15a, a virtualization operating system 15b (hereinafter, referred to as “virtualization OS 15b”), and a guest operating system 15c (hereinafter, referred to as “guest OS 15c”), for example.

The reading unit 17 reads information from a recording medium 18 that is readable by a computer. The recording medium 18 is, for example, an optical disk such as a CD or DVD or a USB flash memory. The reading unit 17 is, for example, an optical drive or a USB terminal. A plurality of computer programs 15a, the virtualization OS 15b, and a plurality of guest OSs 15c are recorded on the recording medium 18, and, by controlling the reading unit 17 to read the recording medium 18, the plurality of computer programs 15a, the virtualization OS 15b, and the plurality of guest OSs 15c are stored in the non-volatile memory of the storage unit 15.

The plurality of computer programs 15a include a program for realizing a function as a management unit 12 and a program (application program) for realizing an application 13b described later in the plurality of VMs 13.

The plurality of guest OSs 15c are operating systems for operating the VMs 13. The guest OSs 15c are not particularly limited, and may be, for example, Autosar (registered trademark), Linux (registered trademark), Android (registered trademark), QNX (registered trademark) or Ubuntu (registered trademark).

Note that the plurality of computer programs 15a, the virtualization OS 15b, and the plurality of guest OSs 15c may be transmitted from the out-of-vehicle device 4 and stored in the storage unit 15 via the communication device 33 and the communication unit 16.

The communication unit 16 includes a first communication interface connected to the plurality of ECUs 31 via the communication line 31a, a second communication interface connected to the plurality of sensors 32 via the communication line 32a, and a third communication interface connected to the communication device 33 via the communication line 33a. The communication standards of the communication lines 31a, 32a, and 33a are not particularly limited, and are, for example, CAN or Ethernet (registered trademark). The communication standards of the communication lines 31a, 32a, and 33a may be the same or may be different.

The control unit 14 realizes various functions described later, by reading out the computer programs 15a, the virtualization OS 15b, and the guest OSs 15c from the storage unit 15, and executing various computations and processing based on these programs and OSs 15a to 15c. The various operations of the management unit 12 and the plurality of VMs 13 are realized by the computations and processing of the control unit 14.

The management unit 12 constructs a plurality of virtual environments in which the plurality of VMs 13 can respectively operate, by allocating the physical resources 11 as appropriate based on the virtualization OS 15b. The virtualization

OS 15b is, for example, Hypervisor (registered trademark). Note that the virtualization OS 15b may be other virtualization software. For example, the virtualization OS 15b may be hosted virtualization software or container virtualization software.

The plurality of VMs 13 each include virtual hardware configured by the physical resources 11 being allocated per allocation time. The virtual hardware has, for example, a virtual control unit, a virtual storage unit, and a virtual communication unit. The VMs 13 function like actual physical ECUs (e.g., ECUs 31), by operating the guest OS 13a on the virtual hardware and operating various applications 13b on this guest OS. The guest OS 13a corresponds to one guest OS 15c allocated by the management unit 12, among the plurality of guest OSs 15c stored in the storage unit 15.

The plurality of VMs 13 include a VM 21, a VM 22, and a VM 23. Henceforth, the VM 21, the VM 22, and the VM 23 will be collectively referred to as “VMs 13” when not particularly distinguishing therebetween. In the example in FIG. 1, the management unit 12 generates these three VMs 13, but the management unit 12 may generate four or more VMs 13.

The VM 21 communicates with the external devices 30. Also, the VM 21

executes processing (real-time processing) that requires real-time performance. The VM 21 transmits request signals to the external devices 30 and receives data transmitted from the external devices 30 in response to the request signals. For example, the VM 21 receives data from the sensors 32, performs various processing on the data, and thereafter transmits the data to the other VMs 22 and 23. The

VM 21 may also relay various data such as update data provided from the out-of-vehicle device 4 via the communication device 33 to the other VMs 22 and 23 and the ECUs 31.

The VM 22 does not communicate with the external devices 30. More specifically, the VM 22 is a VM whose processing is completed within the in-vehicle control device 1. Also, the VM 22 executes real-time processing. The VM 22, for example, determines the state of various parts of the vehicle V1 based on data transmitted to the VM 22 from the VM 21. The VM 22, for example, transmits data relating to determination results to the VM 21.

The VM 23 executes processing that requires comparatively little real-time performance. The VM 23 is, for example, for managing the quality of the in-vehicle control device 1. For example, the VM 23 may collect processing information (e.g., history of processing contents, processing times, etc.) of the VMs 21 and 22 and assess whether the VMs 21 and 22 are functioning efficiently.

### Problem to be Solved by First Embodiment

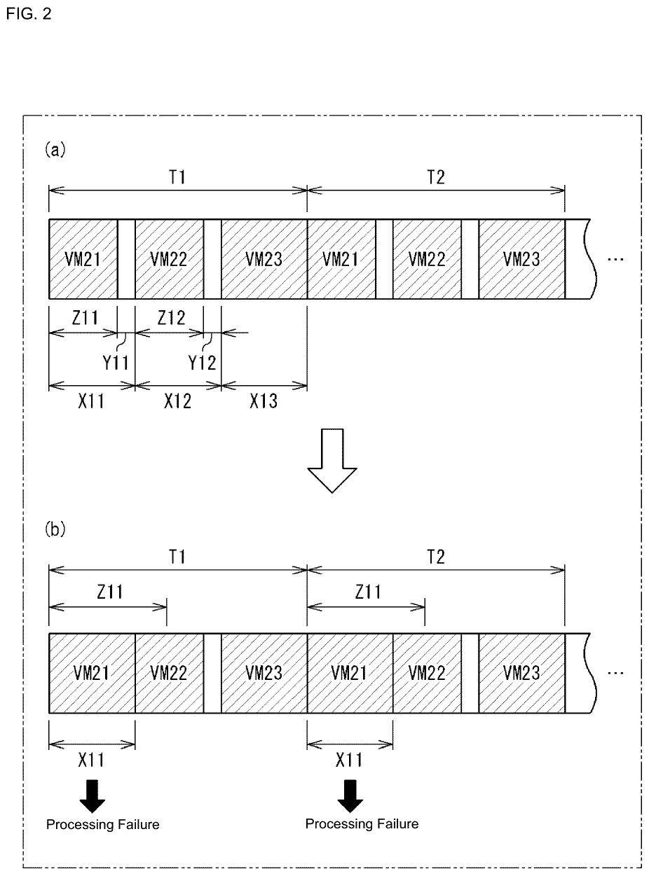

FIG. 2 is a diagram for describing the problem to be solved by the first embodiment. (a) and (b) of FIG. 2 are timing charts showing the allocation times of the VMs 21, 22, and 23. The management unit 12 allocates times for the VMs 21, 22, and 23 to operate for each predetermined cycle T. That is, the management unit 12 has a function as a scheduler.

Reference will now be made to (a) of FIG. 2. The management unit 12 initially only allocates physical resources 11 to the VM 21 during an allocation time X11 in a predetermined cycle T1 (hereinafter, also referred to as “first cycle T1”). The VM 21 uses the allocated physical resources 11 to execute predetermined processing. Hereinafter, the time for which the VMs actually execute processing will be referred to as “processing time”. The VM 21 uses a processing time Z11 to execute the predetermined processing, during the allocation time X11.

In the first cycle T1, the VM 21 executes processing (real-time processing) that cannot be carried over to the next cycle T2 (hereinafter, also referred to as “second cycle T2”). That is, if the processing of the VM 21 is not completed during the allocation time X11, the processing fails. In other words, the processing of the VM 21 is processing that cannot be interrupted and resumed across cycles. Thus, the allocation time X11 is set longer than the processing time Z11, such that the processing time Z11 falls within the allocation time X11 (X11>Z11). Hereinafter, the allocation time not used for VM processing is referred to as “buffer time”. A buffer time Y11 included in the allocation time X11 is derived by subtracting the processing time Z11 from the allocation time X11 (Y11=X11−Z11).

Similarly, in the first cycle T1, the VM 22 executes processing (real-time processing) that cannot be carried over to the second cycle T2. Thus, an allocation time X12 of the VM 22 includes a processing time Z12 for which the VM 22 executes processing and a buffer time Y12 that is not used for the processing of the VM 22.

In the first cycle T1, the VM 23 executes processing that can be carried over to the second cycle T2. That is, the processing of the VM 23 is processing that can be temporarily interrupted when not ended within an allocation time X13 of the VM 23, for example, and resumed in the allocation time X13 of the VM 23 in the following second cycle T2. Thus, the allocation time X13 of the VM 23 is all used as processing time and does not include buffer time. Note that the allocation time X13 may include buffer time.

When the first cycle T1 ends, the management unit 12 similarly allocates the allocation times X11, X12, and X13 to the VMs 21, 22, and 23, respectively, and executes the second cycle T2.

Section (a) of FIG. 2 shows a timing chart in a state where a new external device 30 (e.g., new sensor 32) is used, for example. In the case of a new external device 30, there is no delay in the processing of the VM 21 that communicates with the external device 30, since the external device 30 has hardly deteriorated, and the processing time Z11 falls within the allocation time X11.

Section (b) of FIG. 2 shows a timing chart in a state where an aging external device 30 is used. When an external device 30 deteriorates, the signal output from the external device 30 may become unstable, for example, and it may take longer for the VM 21 to receive data from the external device 30 (e.g., sensor 32).

More specifically, when the signal output from an external device 30 is an abnormal signal (signal strength is weak or extremely strong, or value indicated by the signal is extremely low or extremely high), the VM 21, having received the signal, requests the external device 30 to resend the signal (communication retry). When the number of times that the VM 21 retries communication to the external devices 30 increases, the time taken for the VM 21 to receive the desired data (normal data) from the external device 30 increases by an equivalent amount. Thus, the processing time Z11 of the VM 21 increases.

As shown in (b) of FIG. 2, when the processing time Z11 becomes longer than the allocation time X11, the VM 21 is forced to interrupt the processing, and the processing of the VM 21 fails. For example, in the case where the processing of the VM 21 involves receiving the current value of detection data from a sensor 32, the processing fails if the desired detection data cannot be received from the sensor 32 during the allocation time X11.

Since the processing of the VM 21 cannot be carried over to the following second cycle T2, the processing is executed again from the beginning in the second cycle T2 (the processing is redone). For example, when the VM 21 receives the current value of detection data from a sensor 32, the VM 21 needs to acquire the value currently being detected by the sensor 32. Thus, after the processing is interrupted in the first cycle T1, the VM 21, in the following second cycle T2, receives the current value of detection data from the sensor 32, and does not continue to receive past detection data of the first cycle T1 from the sensor 32.

Since the sensor 32 is already in a deteriorated state due to aging, the signal output from the sensor 32 remains unstable in the allocation time X11 of the second cycle T2, and the processing of the VM 21 is also at risk of failing in the second cycle T2 due to the processing time Z11 of the VM 21 being longer than the allocation time X11.

In this way, when the processing time Z11 increases due to aging deterioration of the external device 30, the VM 21 is at risk of suffering continuous processing failure. In response to this problem, it is conceivable to set the allocation time X11 of the VM 21 excessively in order to secure extra buffer time Y11 in anticipation of an increase in the processing time Z11. However, since the buffer time Y11 is a time during which the VM 21 does not execute processing, the functions of the in-vehicle control device 1 in which the plurality of VMs 13 are configured cannot be efficiently exhibited when the buffer time Y11 occupies a large percentage of the allocation time X11 (when the buffer time Y11 is long).

In view of this, in the present embodiment, an allocation time X11 suitable for the VM 21 that communicates with the new external device 30 is initially set rather than setting an excessive allocation time X11. Then, when a predetermined condition (e.g., elapse of a predetermined time) indicating that the external device 30 has deteriorated is satisfied, the management unit 12 extends the allocation time X11 of the VM 21. Also, the management unit 12 shortens the allocation time X13 of the VM 23 that executes processing that can be carried over to the next cycle, such that the total time of the cycle does not change following the allocation time X11 being extended.

That is, the management unit 12 configures the allocation time X11 of the VM 21 to be short while there is no deterioration in the external device 30 (i.e., while the output of the external device 30 is comparatively stable). For example, the initial allocation time X11 is shorter than the increased processing time Z11 expected after the external device 30 deteriorates. The percentage of the allocation time X11 occupied by the buffer time Y11 is thereby kept comparatively small, and the functions of the in-vehicle control device 1 are efficiently exhibited. Also, when there is a possibility that the external device 30 has deteriorated over time, the management unit 12 suppresses processing failure of the VM 21 by extending the allocation time X11 of the VM 21. The in-vehicle control device 1 can thereby be controlled to function efficiently over a longer period of time.

Hereinafter, a control method performed by the management unit 12 of the first embodiment will be described in detail.

### Control Method

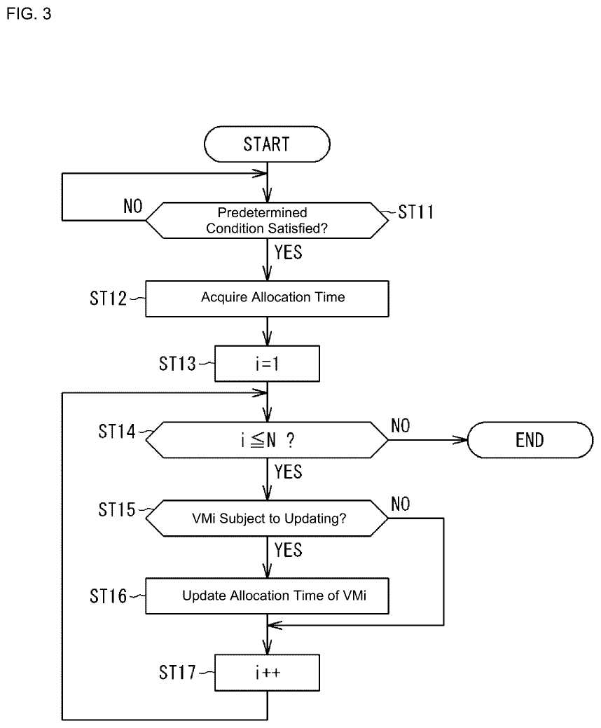

FIG. 3 is a flowchart illustrating the control method according to the first embodiment. FIG. 3 shows various controls that are executed by the management unit 12. These controls are realized by the management unit 12 reading the computer programs 15a from the storage unit 15 and executing various computations and processing. The order of the steps shown in FIG. 3 may be changed as appropriate.

First, the management unit 12 monitors whether a predetermined condition indicating that the external device 30 has deteriorated is satisfied (step ST11). The management unit 12 may execute the monitoring of step ST11 at any time or on a regular basis (e.g., every other week).

he predetermined condition includes, for example, the following (1), (2) or (3).
(1) A prescribed time or longer elapsing from a predetermined reference timepoint P1
(2) The external device 30 operating for a predetermined time or longer from the reference timepoint P1
(3) The vehicle V1 traveling a prescribed distance or longer from the reference timepoint P1

In (1) above, the management unit 12 determines that the external device 30 has deteriorated by the time that has elapsed from the reference timepoint P1, regardless of whether the external device 30 has been operated or whether the vehicle V1 has been driven. For example, the management unit 12 starts a count from the reference timepoint P1 using a timer built into the CPU or the like, and, when the count reaches a value greater than or equal to a predetermined time, determines that the predetermined condition is satisfied.

In (2) above, the management unit 12 determines that the external device 30 has deteriorated by the operating time of the external device 30. For example, the management unit 12 advances the count from the reference timepoint P1 only when the external device 30 is operating, using a timer built into the CPU or the like, and, when the count reaches a value greater than or equal to a predetermined time, determines that the predetermined condition is satisfied.

In (3) above, the management unit 12 determines that the external device 30 has deteriorated by the travel distance of the vehicle V1. For example, the management unit 12 acquires data relating the travel distance of the vehicle V1 from the sensor 32 that detects the travel distance of the vehicle V1, and, when the travel distance from the reference timepoint P1 is longer than or equal to a predetermined distance, determines that the predetermined condition is satisfied.

Here, the reference timepoint P1 includes, for example, the following (4) or (5).
(4) The timepoint at which use of the external device 30 is started
(5) The timepoint at which the allocation time of the VM 21 is extended

In (4) above, the management unit 12 sets the timepoint at which the external device 30 is newly connected to the in-vehicle control device 1 as the reference timepoint P1, for example. Thus, for example, when an old external device 30 is replaced with a new external device 30, the counts of (1) to (3) above are reset. On the other hand, the counts are not reset when the allocation time of the VM 21 is extended.

In (5) above, the management unit 12 sets the timepoint at which the third change control (step ST16) described later is executed as the reference timepoint P1. Thus, when the allocation time of the VM 21 is extended in step ST16, the counts of (1) to (3) above are reset. On the other hand, the counts are not reset when an external device 30 is replaced.

Note that the reference timepoint P1 may include both of (4) and (5) above. That is, the counts of (1) to (3) may be reset both at the time when an external device 30 is replaced and at the time when the allocation time of the VM 21 is extended.

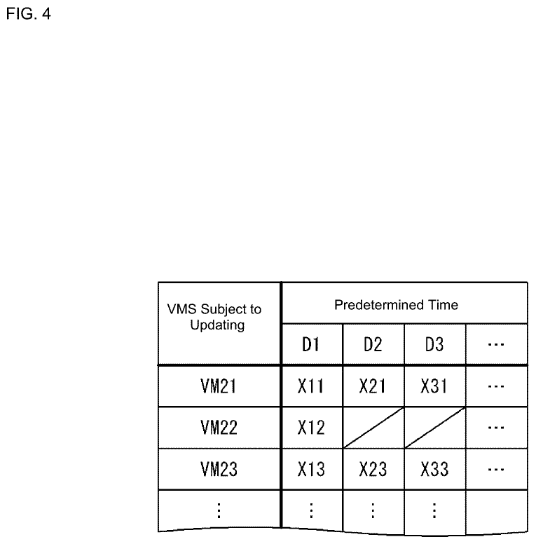

If the predetermined condition is not satisfied (NO in step ST11), the management unit 12 repeats the monitoring of step ST11. On the other hand, if the predetermined condition is satisfied (YES in step ST11), the management unit 12 acquires an updated allocation time (step ST12). Specifically, the management unit 12 acquires an update table shown in FIG. 4 from the storage unit 15.

FIG. 4 is a diagram illustrating the update table according to the first embodiment. In the update table, predetermined times or predetermined distances are associated with allocation times of each of the VMs 21, 22, and 23, and these values are stored as parameters in the storage unit 15. In the example of FIG. 4, the VMs 21 and 23, which are VMs 13 that are subject to updating, are shown in the first column, and the allocation times of the VMs 21, 22, and 23 for each predetermined time are shown in the second column onward. The update table will be described in detail later.

Note that the update table may be stored in the out-of-vehicle device 4. In this case, at the time of execution of step ST12, the management unit 12 acquires the update table from the out-of-vehicle device 4 via the network and the communication device 33. That is, the management unit 12 may acquire an update table in a timely manner through OTA (Over-the-Air) technology.

After acquiring the update table, the management unit 12 sets the value of a variable i to “1” (step ST13) and determines whether the variable i is less than or equal to the number N of VMs 13 configured in the in-vehicle control device 1 (step ST14). In the example of FIG. 1, since there are three VMs 13 (N=3), the first iteration of step ST14 proceeds down the YES route.

Next, the management unit 12 determines whether the i-th VM 13 is subject to updating (step ST15). Here, in the example of FIG. 1, the VM 21, the VM 22, and the VM 23 are respectively defined as a first VM, a second VM, and a third VM. In the first iteration of step ST15, the management unit 12 determines whether the VM 21, which is the first VM 13, is subject to updating. In the present example, the VMs 21 and 23 are subject to updating, and the VM 22 is not subject to updating. Thus, in the first iteration of step ST15, the management unit 12 advances the processing down the YES route.

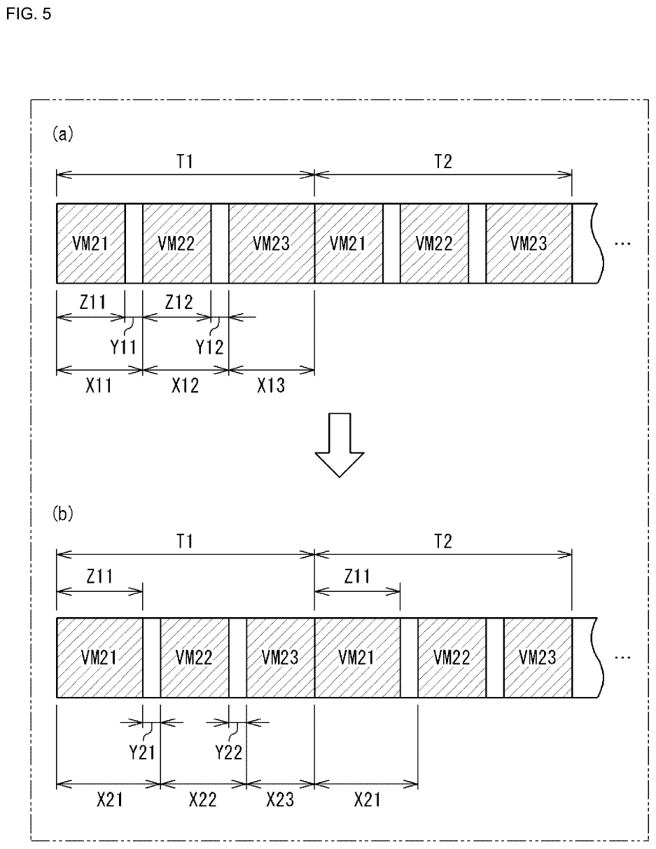

Next, the management unit 12 updates the allocation time of the i-th VM 13 (step ST16). Specifically, the management unit 12 updates the allocation time of the VM 21 with reference to the update table. Here, the update table will be specifically described with reference to FIGS. 4 and 5.

FIG. 5 is a diagram for describing updating of allocation times according to the first embodiment. (a) of FIG. 5 is a timing chart showing the allocation times before updating, and (b) is a timing chart showing the updated allocation times.

The update table of FIG. 4 shows an example in which the predetermined condition is (1) or (2) above and the reference timepoint P1 is (4) above. For example, when a time longer than or equal to a predetermined time D1 and shorter than a predetermined time D2 has elapsed from the reference timepoint P1, the management unit 12 sets the allocation times of the VM 21, the VM 22, and the VM 23 to “X11”, “X12”, and “X13”, respectively. The predetermined time D1 is, for example, “0”, and the allocation times X11, X12, and X13 are the respective initial values of the allocation times of the VMs 21, 22, and 23. For example, as shown in (a) of FIG. 5, due to an event such as replacement of an external device 30 with a new external device, the management unit 12 sets the allocation times X11, X12, and X13, which are the initial values, for the VMs 21, 22, and 23 at the timepoint at which use of the external device 30 is started, with reference to the update table in the storage unit 15.

When a time longer than or equal to the predetermined time D2 and shorter than a predetermined time D3 has elapsed from the reference timepoint P1, the management unit 12 refers to the third column (D2 column) of the update table. Then, as shown in (b) of FIG. 5, the management unit 12 sets the allocation time to “X21”, which is longer than X11 when updating the VM 21, and sets the allocation time to “X23”, which is shorter than X13 when updating the VM 23. Since the allocation time of the VM 22 is not subject to updating when the elapsed time is longer than or equal to the predetermined time D2 and shorter than the predetermined time D3, a value is not shown in the update table. The predetermined time D2 is, for example, 30 days, and the predetermined time D3 is, for example, 90 days.

The amount of increase in the allocation time from X11 to X21 and the amount of decrease in the allocation time from X13 to X23 are equal in length (X21−X11=X13−X23). Thus, the cycles before and after updating the allocation times of VMs 21 and 23 are equal in length (X11+X12+X13=X21+X12+X23).

Similarly, when a time longer than or equal to the predetermined time D3 has elapsed from the reference timepoint P1, the management unit 12 sets the allocation times of the VM 21 and the VM 23 to “X31” and “X33”, respectively, with reference to the fourth column (D3 column) of the update table. The X31 is longer than the X21, and the X33 is shorter than the X23. In this way, the management unit 12 gradually increases the allocation time of the VM 21 and gradually shortens the allocation time of the VM 23, every time a longer predetermined time elapses (or every time the predetermined distance becomes longer). The amount of increase in the allocation time from X21 to X31 and the amount of decrease in the allocation time from X23 to X33 are also equal in this case (X31−X21=X23−X33).

In the following description, an example in which the predetermined condition of step ST11 is satisfied by the predetermined time D2 elapsing from the reference timepoint P1, for example, will be considered. In this case, in the first iteration of step ST16, the management unit 12 extends the allocation time of the VM 21 from “X11” to “X21”. Next, the management unit 12 adds “1” to the variable i (step ST17). The variable i thereby becomes “2”.

After step ST17, the management unit 12 returns the processing to step ST14. Since the variable i (=2) is still less than or equal to the number N (=3) of VMs 13, the second iteration of step ST14 also proceeds down the YES route. Next, the management unit 12 executes the second iteration of step ST15. The VM 22, which is the second VM 13, does not communicate with the external devices 30 and, furthermore, performs real-time processing, and thus is not subject to updating. Thus, in the second iteration of step ST15, the management unit 12 advances the processing down the NO route and skips step ST16. Next, the management unit 12 adds “1” to the variable i (step ST17). The variable i thereby becomes “3”.

After the second iteration of step ST17, the management unit 12 executes the third iteration of step ST14. Since the variable i (=3) is less than or equal to the number N (=3) of VMs 13, the third iteration of step ST14 also proceeds down the YES route. Next, the management unit 12 executes the third iteration of step ST15, advances the processing down the YES route since the VM 23 is subject to updating, and shortens the allocation time of the VM 23 from “X13” to “X23” with reference to the update table (step ST16). Next, the management unit 12 adds “1” to the variable i to set the variable i to “4” (step ST17).

After the third iteration of step ST17, the management unit 12 executes the fourth iteration of step ST14. Since the variable i (=4) is larger than the number N (=3) of VMs 13, the fourth iteration of step ST14 proceeds down the NO route, and the series of controls by the management unit 12 ends. The series of controls from step ST11 to step ST17 is also referred to as “the third change control” as appropriate.

As described above, in relation to schedule management of the plurality of VMs 13, the management unit 12 determines deterioration of the external devices 30 based on a predetermined condition, and, when deterioration of an external device 30 is anticipated, extends the allocation time of the VM 21 (VM that communicates with external devices 30 and performs real-time processing).

As shown in (b) of FIG. 5, even if the processing time Z11 of the VM 21 becomes longer than the initial allocation time X11 due to deterioration of an external device 30, processing failure of the VM 21 can thereby be suppressed, by extending the allocation time from “X11” to “X21”. By adopting such a configuration, the processing of the VM 21 can be continued even after long-term use, while keeping the buffer time Y11 from initially being set excessively long, thus enabling the in-vehicle control device 1 to be controlled to function efficiently.

Also, the management unit 12 shortens the allocation time of the VM 23 that executes processing that can be carried over to the next cycle, following the allocation time of the VM 21 being extended. That is, the management unit 12 devises time to be additionally allocated to the VM 21, by shortening the allocation time of the VM 23. Since the processing of the VM 23 can be interrupted and resumed in the next cycle, there is little possibility that the functions of the in-vehicle control device 1 will be degraded, even if the allocation time of the VM 23 is shortened (at least, the risk of functional degradation of the in-vehicle control device 1 is low, compared to when processing failure of the VM 21 is ongoing).

Also, since the management unit 12 shortens the allocation time of the VM 23 by the amount that the allocation time of the VM 21 is extended, the time taken for one cycle does not change before and after updating of the allocation times (e.g., T1=T2). Thus, since the processing load of the management unit 12 can be suppressed, more physical resources 11 can be allocated to the plurality of VMs 13 rather than the management unit 12, and the in-vehicle control device 1 can be controlled to function more efficiently.

### SECOND EMBODIMENT

Next, a second embodiment of the present disclosure will be described. In the second embodiment, configuration that is the same as the first embodiment is given the same reference numerals and description thereof will be omitted. In the second embodiment, the content of the control method performed by the management unit 12 differs from the first embodiment.

### Problem to be solved by Second Embodiment

In the first embodiment, an increase in the processing time Z11 of the VM 21 caused by instability in the output of an external device 30 due to aging deterioration was described. Aging deterioration of an external device 30 can be resolved by, for example, replacing the external device 30, but basically the situation continues to deteriorate over time. Thus, in the first embodiment, the allocation time of the VM 21 is sequentially updated over time to be longer, such as from the initial X11 to X21 which is longer than X11, and thereafter to X31 which is longer than X21.

On the other hand, apart from aging deterioration, the output of an external device 30 may temporarily become unstable due to a disturbance. When the external device 30 is a sensor 32 that monitors the state around the vehicle V1, output may become temporarily unstable due to being affected by electromagnetic waves around the vehicle V1 (e.g., radio tower in the vicinity of vehicle V1), weather (e.g., rain, snow, extreme heat, extreme cold), bad roads (e.g., rough roads), and the like. In such cases, the processing time Z11 for the VM 21 to receive data from the external device 30 may temporarily increase.

In this way, when the processing time Z11 increases as a result of

temporary instability in the output of an external device 30 due to a disturbance or the like, the VM 21 is also at risk of temporarily suffering processing failure. For example, when the allocation time X11 of the VM 21 is set excessively in anticipation of such a temporary increase in the processing time Z11, the buffer time Y11 will be excessive when the processing time Z11 does not increase, and the efficiency of the in-vehicle control device 1 will deteriorate. On the other hand, when the allocation time X11 of the VM 21 is set without consideration for the temporary increase in the processing time Z11, the VM 21 will suffer from processing failure when the processing time Z11 increases, and the efficiency of the in-vehicle control device 1 will deteriorate.

In view of this, in the present embodiment, the allocation time X11 is not set excessively, and an allocation time X11 suitable for the VM 21 that communicates with the external devices 30 in a normal state in which the output is not unstable is initially set. The management unit 12 then constantly collects the processing time Z11 of the VM 21 and extends or shortens the allocation time of the VM 21 according to the processing time Z11. For example, when an increase in the processing time Z11 is detected, the management unit 12 extends the allocation time X11 of the VM 21 to X41, and, when a decrease in the processing time Z11 is detected thereafter, shortens the allocation time X41 of the VM 21 to X51. Also, the management unit 12 shortens or extends the allocation time of the VM 23 that executes processing that can be carried over to the next cycle, such that the total time of the cycle does not change following the allocation time of the VM 21 being extended or shortened.

That is, while the external devices 30 are largely unaffected by disturbances and operating normally (i.e., while the output of the external devices 30 is comparatively stable), the management unit 12 keeps the percentage of the allocation time X11 occupied by the buffer time Y11 comparatively small, by setting the allocation time X11 of the VM 21 to be comparatively short, and allows the functions of the in-vehicle control device 1 to be efficiently exhibited. Here, the allocation time X11 is longer than the processing time Z11 under normal conditions, and shorter than the processing time Z11 when the output of the external device 30 becomes unstable due to a disturbance.

Also, the management unit 12 suppresses processing failure of the VM 21 by extending the allocation time of the VM 21, only while the processing time Z11 temporarily increases, such as during a period in which the output of the external device 30 becomes unstable due to a disturbance. Also, when the processing time Z11 decreases, the management unit 12 shortens the buffer time of the VM 21 to improve the efficiency of the in-vehicle control device 1 by shortening the allocation time of the VM 21. By flexibly updating the allocation time of the VM 21 according to the processing time Z11 of the VM 21 in this way, the in-vehicle control device 1 can be controlled to function efficiently over a longer period of time. Hereinafter, the control method performed by the management unit 12 of the second embodiment will be described in detail.

### Control Method

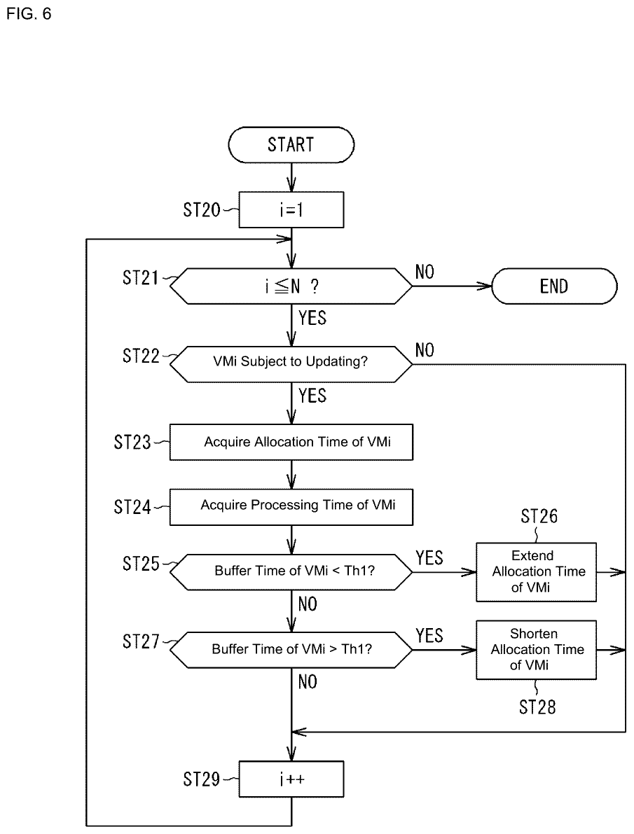

FIG. 6 is a flowchart illustrating the control method according to the second embodiment. FIG. 6 shows various controls executed by the management unit 12. These controls are realized by the management unit 12 reading the computer programs 15a from the storage unit 15 and executing various computations and processing. The order of the steps shown in FIG. 6 may be changed as appropriate.

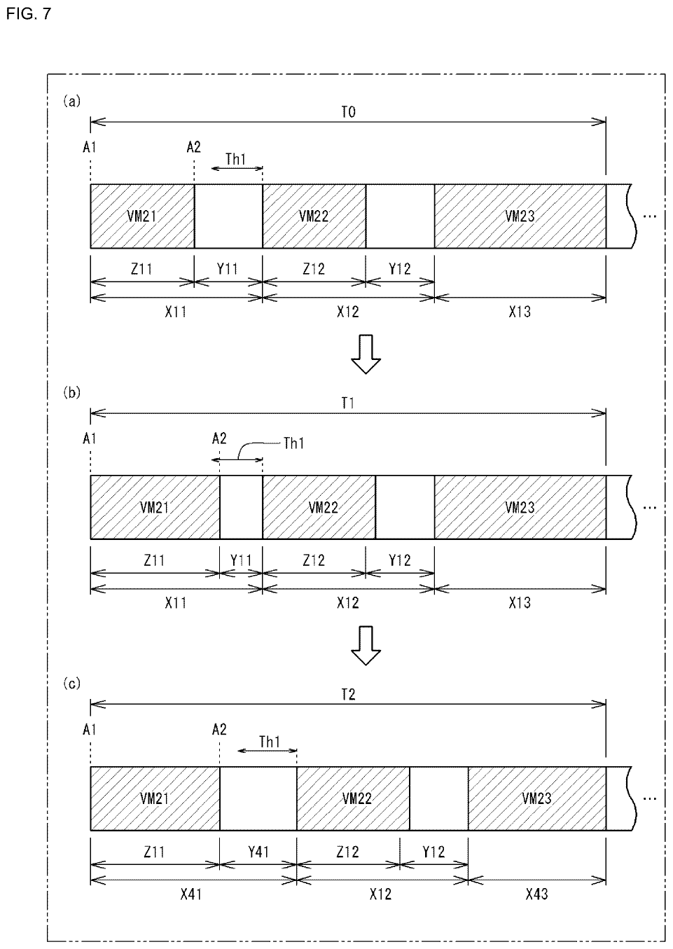

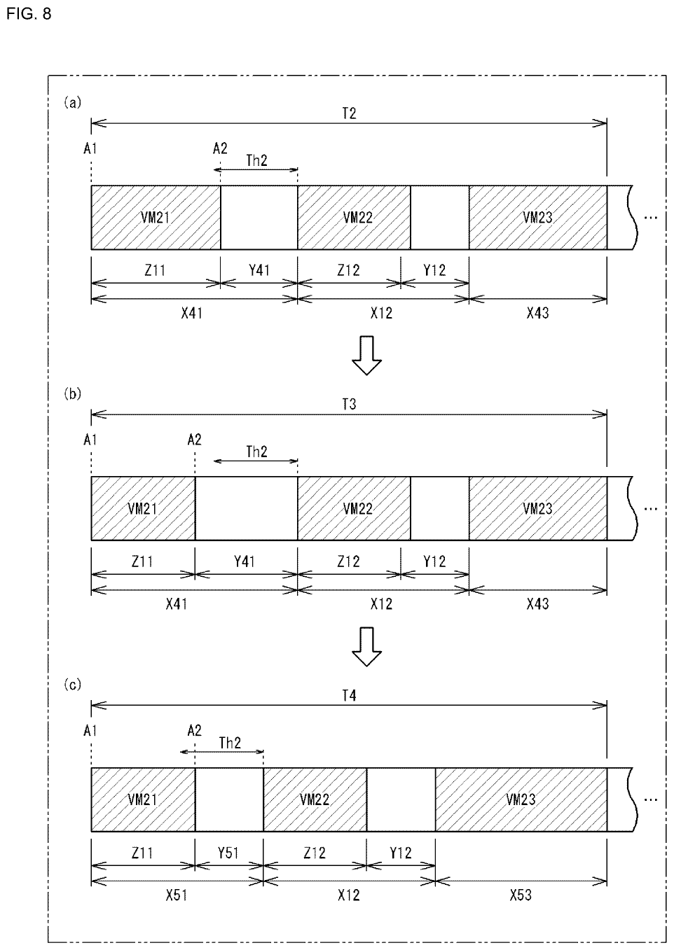

FIGS. 7 and 8 are diagrams for describing updating of allocation times according to the second embodiment. FIG. 7 shows the change in cycles T0, T1, and T2 in order from (a). FIG. 8 shows the change in cycles T2, T3, and T4 in order from (a). Cycles T0 to T4 are continuous cycles in the stated order, and, for example, cycle T1 is the next cycle after cycle T0, and cycle T2 is the next cycle after cycle T1.

In the present example, the output of the external device 30 temporarily becomes unstable during cycle T1 to cycle T2 and becomes stable again in cycle T3. In cycles T0 and T4, the output of the external device 30 is stable. Thus, the processing time Z11 of the VM 21 that communicates with the external device 30 increases in cycles T1 and T2, and the processing time Z11 is normal in the other cycles T0, T3, and T4.

The management unit 12 executes the control method shown in FIG. 6 at the end of cycles T0 to T4, for example. The management unit 12 then updates various allocation times in the cycles (e.g., cycle T2) that are executed from cycle T1 onward, based on the execution content before cycle T1, for example.

First, the management unit 12 sets the value of the variable i to “1” (step ST20) and determines whether the variable i is less than or equal to the number N of VMs 13 configured in the in-vehicle control device 1 (step ST21). In the example of FIG. 1, since the number of VMs 13 is 3 (N=3), the first iteration of step ST20 proceeds down the YES route.

Next, the management unit 12 determines whether the i-th VM 13 is subject to updating (step ST22). In the first iteration of step ST22, the management unit 12 determines whether the VM 21, which is the first VM 13, is In the present example, the VM 21, which communicates with subject to updating. the external devices 30 and performs real-time processing, is subject to updating, and the VMs 22 and 23 are not subject to updating. Thus, in the first iteration of step ST22, the management unit 12 advances the processing down the YES route.

Next, the management unit 12 acquires the current allocation time of the i-th VM 13 (step ST23). For example, the management unit 12 reads out the allocation time X11 currently set for the VM 21 from the storage unit 15.

Thereafter, the management unit 12 acquires the processing time of the i-th VM 13 (step ST24). For example, the management unit 12 acquires the processing time Z11 of the VM 21 in cycle T0. More specifically, in cycle T0, the management unit 12 acquires a processing start time A1 of the VM 21 and a processing end time A2 of the VM 21. The management unit 12 then subtracts the time A1 from the time A2 to obtain the processing time Z11.

Next, the management unit 12 calculates the buffer time of the i-th VM 13, based on the allocation time and the processing time respectively acquired in steps ST23 and 24, and determines whether the calculated buffer time is lower than a first predetermined value Th1 (step ST25). For example, the management unit 12 calculates the buffer time Y11 of the VM 21 in cycle T0 by subtracting the processing time Z11 from the allocation time X11 (Y11=X11−Z11). The management unit 12 then determines whether the calculated buffer time Y11 is lower than the first predetermined value Th1 (Y11<Th1).

The first predetermined value Th1 is, for example, a value smaller than the buffer time Y11 (e.g., buffer time Y11 in (a) of FIG. 7) obtained by subtracting the normal processing time Z11 of the VM 21 from the allocation time X11 of the VM 21 set as an initial value. The first predetermined value Th1 is, for example, within a range of one-third to two-thirds of the buffer time Y11 in (a) of FIG. 7, and is, for example, half the buffer time Y11. The normal processing time Z11 is the processing time Z11 of the VM 21 when the external devices 30 are largely unaffected by disturbances and operating normally, and is, for example, the processing time Z11 in (a) of FIG. 7.

Thus, in step ST25, the management unit 12 determines whether the buffer time of the i-th VM 13 is smaller than normal to at least some degree. In other words, the management unit 12 determines that the processing time of the i-th VM 13 is at risk of increasing and exceeding the allocation time set for the VM 13. When it is determined that the buffer time is lower than the first predetermined value Th1 (YES in step ST25), the management unit 12 extends the allocation time of the i-th VM 13 (step ST26).

Since the buffer time Y11 of the VM 21 in cycle T0 is greater than or equal

to the first predetermined value Th1, the management unit 12 advances the processing down the NO route in the first iteration of step ST25. In this case, the management unit 12 determines whether the calculated buffer time exceeds a second predetermined value Th2 (step ST27). The second predetermined value Th2 is a value larger than the buffer time Y11 (e.g., buffer time Y11 in (a) of FIG. 7) obtained by subtracting the normal processing time Z11 of the VM 21 from the allocation time X11 of the VM 21 set as an initial value, for example. That is, the second predetermined value Th2 is larger than the first predetermined value Th1. The second predetermined value Th2 is, for example, within a range of four thirds to eighth thirds of the buffer time Y11 in (a) of FIG. 7, and is, for example, twice the buffer time Y11.

Thus, in step ST27, the management unit 12 determines whether the buffer time of the i-th VM 13 is larger than normal to at least some degree. In other words, the management unit 12 determines there is a possibility that inefficiency in the controls of the in-vehicle control device 1 will arise due to the processing time being excessively short relative to the extended allocation time set for the i-th VM 13, as a result of the processing time of the i-th VM 13 decreasing after initially increasing. When it is determined that the buffer time exceeds the second predetermined value Th2 (YES in step ST27), the management unit 12 shortens the allocation time of the i-th VM 13 (step ST28).

Since the buffer time Y11 of the VM 21 in cycle T0 is less than or equal to the second predetermined value Th2 (Y11≤Th2), the management unit 12, in the first iteration of step ST27, advances the processing down the NO route.

Thereafter, the management unit 12 adds “1” to the variable i (step ST29). The variable i thereby becomes “2”.

After step ST29, the management unit 12 returns the processing to step ST21. Since the variable i (=2) is still less than or equal to the number N (=3) of VMs 13, the second iteration of step ST21 also proceeds down the YES route. Next, the management unit 12 executes the second iteration of step ST22. The VM 22, which is the second VM 13, does not communicate with the external devices 30 and is thus not subject to updating. Thus, in the second iteration of step ST22, the management unit 12 advances the processing down the NO route and skips steps ST23 to ST28. Next, the management unit 12 adds “1” to the variable i (step ST29), and the variable i becomes “3”.

After the second iteration of step ST29, the management unit 12 executes the third iteration of step ST21 and advances the processing down the YES route, since the variable i (=3) is less than or equal to the number N (=3) of VMs 13. Next, the management unit 12 executes the third iteration of step ST22, and since the VM 23 is not subject to updating, the management unit 12 advances the processing down the NO route and adds “1” to the variable i to set the variable i to “4” (step ST29).

After the third iteration of step ST29, the management unit 12 executes the fourth iteration of step ST21. Since the variable i (=4) is larger than the number N (=3) of VMs 13, the fourth iteration of step ST21 proceeds down the NO route, and the series of controls by the management unit 12 in cycle T0 ends. In this series of controls, the VM 21 performs processing in the normal processing time Z11, and thus updating of the allocation time X11 and the like is not executed.

Next, the management unit 12 executes the control method shown in FIG. 6 at the end of the first cycle T1. First, the management unit 12 executes steps ST20 to ST24, similarly to in cycle T0.

Next, the management unit 12 calculates the buffer time Y11 of the VM 21, based on the allocation time X11 and the processing time Z11 respectively acquired in steps ST23 and 24, and determines whether the calculated buffer time Y11 is lower than the first predetermined value Th1 (step ST25).

As shown in (b) of FIG. 7, in the first cycle T1, the processing time Z11 of the VM 21 has increased, and the buffer time Y11 of the VM 21 has decreased by an equivalent amount. Also, since the buffer time Y11 of the VM 21 in the first cycle T1 is lower than the first predetermined value Th1, the management unit 12 advances the processing down the YES route in the first iteration of step ST25.

In this case, the management unit 12 extends the allocation time X11 of the VM 21 (step ST26). For example, the management unit 12 changes the allocation time of the VM 21 to “X41”, which is longer than “X11”. The updated allocation time X41 may, for example, be stored as a predetermined parameter in the storage unit 15 or may be calculated based on the current allocation time X11 or processing time Z11.

For example, the management unit 12 may set a value obtained by adding a predetermined value (e.g., first predetermined value Th1) to the current allocation time X11 as the updated allocation time X41 (X41=X11+Th1). Also, the management unit 12 may set a value obtained by adding a predetermined value (e.g., second predetermined value Th2) to the current processing time Z11 as the updated allocation time X41 (X41=Z11+Th2).

Also, in step ST26, the management unit 12 shortens the allocation time of a VM 13 (VM 23 in the present example) that does not execute real-time processing, by the extension amount of the allocation time X11. For example, the management unit 12 changes the allocation time X13 of the VM 23 to X43, which is shorter than X13. The amount of increase in the allocation time of the VM 21 (X41−X11) is equal to the amount of decrease in the allocation time in the VM 23 (X13−X43). The allocation time of the VM 21 can thereby be adjusted without changing the time taken for one cycle.

After extending the allocation time X11, the management unit 12 adds “1”

to the variable i to set the variable i to “2” (step ST29). After step ST29, the management unit 12 returns the processing to step ST21. Since neither the VM 22 nor the VM 23 is subject to updating, steps ST21, ST22, and ST29 are executed twice each, similarly to the processing in cycle T0, and the series of controls by the management unit 12 in the first cycle T1 ends as a result of the fourth iteration of step ST21 proceeding down the NO route.

The series of update controls of steps ST25 and ST26 by the management unit 12 is also referred to as “the first change control” as appropriate. In the first change control, an increase in the processing time Z11 and a decrease in the buffer time Y11 of the VM 21 arise, and thus the management unit 12 executes a control to extend the allocation time X11 of the VM 21.

As a result of the first change control, in the second cycle T2 that follows the first cycle T1, the management unit 12 allocates physical resources 11 to the VMs 21, 22, and 23 for each allocation time shown in (c) of FIG. 7. Since the allocation time of the VM 21 has been extended to X41, the buffer time Y41 (=X41−Z11) in the second cycle T2 is greater than or equal to the first predetermined value Th1, even when the processing time Z11 increases. In this way, the buffer time can be secured and processing failure of the VM 21 can be suppressed, as a result of the management unit 12 extending the allocation time of the VM 21 following an increase in the processing time of the VM 21.

In particular, the management unit 12 extends the allocation time X11, triggered by the buffer time Y11 decreasing to lower than the first predetermined value Th1. Since the allocation time X11 can thus be extended while keeping the processing time Z11 of the VM 21 from actually exceeding the allocation time X11, processing failure of the VM 21 can be suppressed more reliably. As a result, the functions of the in-vehicle control device 1 can be more efficiently exhibited.

Next, a control for shortening the extended allocation time X41 will be described, with reference to FIGS. 6 and 8. Cycle T2 in (c) of FIG. 7 is shown again in (a) of FIG. 8 to contrast with cycle T3 described below. In cycle T3, the processing time Z11 of the VM 21 decreases. Thus, the management unit 12 reduces the surplus buffer time, by shortening the allocation time of the VM 21, according to the decrease in the processing time Z11.

The management unit 12 executes the control method shown in FIG. 6 at the end of cycle T3. First, the management unit 12 executes steps ST20 to ST24, similarly to in cycle T0.

Next, the management unit 12 calculates the buffer time Y41 of the VM 21, based on the allocation time X41 and the processing time Z11 of the VM 21 respectively acquired in steps ST23 and 24, and determines whether the calculated buffer time Y41 is lower than the first predetermined value Th1. As shown in (b) of FIG. 8, in cycle T3, the processing time Z11 of the VM 21 has decreased, and the buffer time Y41 of the VM 21 has increased by an equivalent amount. Since the buffer time Y41 of the VM 21 in cycle T3 is greater than or equal to the first predetermined value Th1, the management unit 12 then advances the processing down the NO route in the first iteration of step ST25.

Next, the management unit 12 determines whether the buffer time Y41 exceeds the second predetermined value Th2 (step ST27). In the case of the present example, the buffer time Y41 exceeds the second predetermined value Th2 (Y41>Th2), and thus the management unit 12 advances the processing down the YES route in step ST27 and shortens the allocation time X41 of the VM 21 (step ST28).

For example, the management unit 12 changes the allocation time of the VM 21 to “X51”, which is shorter than “X41”. The updated allocation time X51 may, for example, be stored as a predetermined parameter in the storage unit 15 or may be calculated based on the current allocation time X41 or the processing time Z11.

For example, the management unit 12 may set a value obtained by subtracting a predetermined value (e.g., first predetermined value Th1) from the current allocation time X41 (X51=X41−Th1) as the updated allocation time X51.

Also, the management unit 12 may return the allocation time of the VM 21 to the pre-extension allocation time X11 (X51=X11). Also, the management unit 12 may set a value obtained by adding a predetermined value (e.g., second predetermined value Th2) to the current processing time Z11 as the updated allocation time X51 (X51=Z11+Th2).

Also, in step ST28, the management unit 12 extends the allocation time of the VM 13 (VM 23 in the present example) that does not execute real-time processing, by the shortened amount of the allocation time X41. For example, the management unit 12 changes the allocation time X43 of the VM 23 to X53, which is longer than X43. The amount of decrease (X41−X51) in the allocation time of the

VM 21 is equal to the amount of increase (X53−X43) in the allocation time of the VM 23. The allocation time of the VM 21 can thereby be adjusted, without changing the time taken for one cycle.

After shortening the allocation time X41, the management unit 12 adds “1” to the variable i to set the variable i to “2” (step ST29). After step ST29, the management unit 12 returns the processing to step ST21. Since neither the VM 22 nor the VM 23 is subject to updating, steps ST21, ST22, and ST29 are executed twice each, similarly to the processing in cycle T0, and the series of controls by the management unit 12 in cycle T3 ends as a result of the fourth iteration of step ST21 proceeding down the NO route.

The series of update controls of steps ST27 and ST28 by the management unit 12 is also referred to as “the second change control” as appropriate. As a result of the second change control, the management unit 12, in cycle T4 following cycle T3, allocates physical resources 11 to the VMs 21, 22, and 23 for each allocation time shown in (c) of FIG. 8. Since the allocation time of the VM 21 is shortened to X51, the buffer time Y51 (=X51−Z11) in cycle T4 is less than or equal to the second predetermined value Th2, even when the processing time Z11 decreases. In this way, the buffer time can be kept from becoming excessive, by the management unit 12 shortening the allocation time of the VM 21 following a decrease in the processing time of the VM 21, and the functions of the in-vehicle control device 1 can be more efficiently exhibited.

### Modifications

Hereinafter, modifications of the embodiments will be described. In the modifications, configuration that is the same as the embodiments will be given the same reference numerals and description thereof will be omitted.

### Modifications of First Embodiment

In the above first embodiment, the management unit 12 extends the allocation time of the VM 21 based on an update table set in advance. However, an update table need not be set, and, for example, the management unit 12 may change to an allocation time X21 obtained by adding a predetermined percentage (e.g., 20%) of the allocation time X11 of the VM 21 to X11 (i.e., X21 is 1.2 times X11) when the predetermined condition is satisfied. In this case, for example, the management unit 12 extends the allocation time by 20% each time the predetermined condition is satisfied, and thus an update table is not required.

In the above first embodiment, only one VM 21 is provided. However, there may be a plurality of VMs 21 whose allocation time is extended by the management unit 12. For example, the management unit 12 may extend the allocation time X11 of each of two VMs 21 to the allocation time X21. In this case, the management unit 12 shortens the allocation time X13 of the VM 23 by the total time of the extended amount of the allocation times of the plurality of VMs For example, when the allocation times of two VMs 21 are each extended by a time (X21−X11), the management unit 12 shortens the allocation time of the VM 23 by the total time thereof (X23=X13−2. (X21−X11)).

In the above first embodiment, the management unit 12 shortens the allocation time of the VM 23, based on an update table set in advance. However, the management unit 12 may be configured to calculate the extension amount of the allocation time of the VM 21 and shorten the allocation time of the VM 23 by the calculated extension amount.

### Modifications of Second Embodiment

### Combination of First and Second Embodiments

The above first embodiment and second embodiment may be combined. For example, the management unit 12 may initially execute the third change control shown in FIG. 3, and thereafter execute the first change control shown in FIG. 6.

By adopting such a configuration, the allocation time can be additionally extended, in a state where the allocation time has been extended to an allocation time (e.g., X21) that takes into account the increase in the processing time Z11 due to aging deterioration of the external device 30 by the third change control, by further taking into account the temporary increase in the processing time Z11 caused by a disturbance of the external device 30 or the like. Since the allocation time can thereby be set in accordance with the current situation, the functions of the in-vehicle control device 1 can be more efficiently exhibited.

### Control Based on Number of Communication Retries

As described in step ST24 of FIG. 6, the first change control of the above second embodiment needs to acquire the processing time Z11 of the VM 21 at the end of each cycle. Here, as aforementioned, the number of times communication from the VM 21 to an external device 30 is retried increasing as a result of the output of the external device 30 becoming unstable due to a disturbance or the like causes the processing time Z11 to increase.

In view of this, before executing step ST24, the management unit 12 may count the number of communication retries from the VM 21 to the external device 30 in the cycle. In this case, a configuration may be adopted in which step ST24 is only executed when the number of communication retries exceeds the number of communication retries in the previous cycle by a predetermined value or more, and if the number of communication retries does not exceed the number of communication retries in the previous cycle by the predetermined value or more, steps ST24 to ST28 are all skipped and the processing advances to step ST29.

That is, a configuration may be adopted in which the management unit 12 only executes the first change control (steps ST25 and ST26) when the number of communication retries to an external device 30 by the VM 21 increases. By adopting such a configuration, the management unit 12 only acquires the processing time Z11 when an increase in the processing time Z11 resulting from an increase in the number of communication retries is expected, and does not acquire the processing time Z11 in other cases, thus enabling the control load of the management unit 12 to be reduced.

Also, as aforementioned, the number of times communication from the VM 21 to the external device 30 is retried decreasing (returning to normal) as a result of the influence of a disturbance or the like being removed and the output of the external device 30 becoming stable again causes the processing time Z11 to decrease.

In view of this, in the case where the number of communication retries from the VM 21 to the external device 30 in the current cycle is counted before executing step ST24, the management unit 12 only executes step ST24 if the number of communication retries is lower than the number of communication retries in the previous cycle by a predetermined value or more, and skips all of steps ST24 to ST28 and advances the processing to step ST29 if the number of communication retries is not lower than the number of communication retries in the previous cycle by the predetermined value or more.

That is, a configuration may be adopted in which the management unit 12 only executes the second change control (steps ST27 and ST28) when the number of communication retries to the external device 30 by the VM 21 decreases. By adopting such a configuration, the management unit 12 only acquires the processing time Z11 when the number of communication retries increases or decreases beyond a predetermined range, and otherwise does not acquire the processing time Z11, thus enabling the control load of the management unit 12 to be reduced.

### Rate of Change of Buffer Time

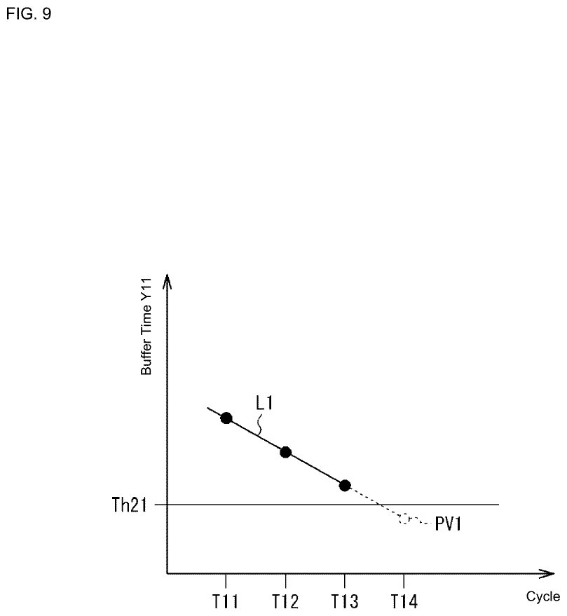

FIG. 9 is a diagram for describing the buffer time Y11 according to a modification of the second embodiment.

The management unit 12 of the above second embodiment extends the allocation time of the VM 21 when the buffer time Y11 is lower than the first predetermined value Th1 (step ST26), and shortens the allocation time of the VM 21 when the buffer time Y11 exceeds the second predetermined value Th2 (step ST28). However, the management unit 12 may extend or shorten the allocation time of the VM 21 based on the rate of change in the buffer time Y11.

For example, in step ST25, the management unit 12 calculates an approximate straight line L1 of the buffer time Y11 in a plurality (e.g., three) of continuous cycles (e.g., cycles T11, T12, and T13 as shown in FIG. 9) by the least squares method. The management unit 12 then acquires the slope of the approximate straight line L1 as a rate of change al of the buffer time Y11. When the rate of change al of the buffer time Y11 is lower than the first predetermined value Th11 (here, Th11<0), the management unit 12 extends the allocation time of the VM 21 (step ST26).

Under normal conditions, the buffer time Y11 is largely unchanged in the plurality of continuous cycles T11, T12, and T13, and thus the slope (rate of change α1) of the approximate straight line L1 is “0” or a neighboring value thereof. On the other hand, when the processing time Z11 increases and the buffer time Y11 decreases, the slope of the approximate straight line L1 will be smaller than 0.

Thus, the management unit 12 may extend the allocation time of the VM 21 when the rate of change al of the buffer time Y11 is lower than the first predetermined value Th11, which is a negative number.

Similarly, in step ST27, the management unit 12 shortens the allocation time of the VM 21 when the rate of change al of the buffer time Y11 exceeds the second predetermined value Th12 (here, Th12>0) (step ST28). When the processing time Z11 decreases and the buffer time Y11 increases, the slope of the approximate straight line L1 becomes larger than 0. Thus, the management unit 12 may shorten the allocation time of the VM 21 when the rate of change α1 of the buffer time Y11 exceeds the second predetermined value Th12, which is a positive number.

### Prediction of Buffer Time

The management unit 12 of the above second embodiment extends or shortens the allocation time of the VM 21, based on the actual buffer time Y11 in cycle T1, for example. However, the management unit 12 may predict the buffer time Y11 of the next cycle, based on a plurality of buffer times Y11 in a plurality of continuous cycles, and extend or shorten the allocation time of the VM 21 based on the predicted value.

For example, in step ST25, the management unit 12 calculates the approximate straight line L1 in a similar manner to that described above. When the approximate straight line L1 is extended beyond cycle T13, as shown in FIG. 9, the allocation time of the VM 21 is extended if the value PV1 of the approximate line L1 in the next cycle 14 after cycle T13 (or cycle T15 two cycles after cycle T13) is lower than a first predetermined value Th21. Here, the first predetermined value Th21 is, for example, a value comparable to the first predetermined value Th1 described above.

The value PV1 is a predicted value obtained by extending the approximate straight line L1. By adopting such a configuration, the management unit 12 can preemptively extend the allocation time of the VM 21, before the actual buffer time Y11 decreases to some degree. Thus, processing failure in the VM 21 can be suppressed more reliably.

Similarly, in step ST27, when the approximate straight line L1 is extended beyond cycle T13, the management unit 12 shortens the allocation time of the VM 21 if the value PV1 of the approximate line L1 in the next cycle 14 (or cycle T15) after cycle T13 exceeds a second predetermined value Th22 (step ST28). Here, the second predetermined value Th22 is, for example, a value comparable to the second predetermined value Th2 described above.

By adopting such a configuration, the management unit 12 can preemptively shorten the allocation time of the VM 21 before the actual buffer time Y41 increases to some degree. Thus, the functions of the in-vehicle control device 1 can be more efficiently exhibited.

Note that, in the above description, the predicted buffer time PV1 is acquired based on the approximate straight line L1, but the management unit 12 may acquire the buffer time prediction value PV1 by other methods. For example, the management unit 12 may predict the buffer time in the next cycle, based on a plurality of buffer times of a plurality of continuous cycles, using a learning model acquired by machine learning or deep learning.

### Supplementary Notes

The above description includes features appended below.

### Supplementary Note 1

An in-vehicle control device to be installed in a vehicle, including: physical resources including a control unit, a storage unit, and a communication unit; and a management unit configured to generate a plurality of virtual machines by allocating the physical resources for each allocation time, the plurality of virtual machines including: a first virtual machine configured to communicate with an external device provided outside the in-vehicle control device and execute processing not carriable over to a next cycle; and a second virtual machine configured to execute processing carriable over to the next cycle, and the management unit executing a third change control for extending an allocation time of the first virtual machine and shortening an allocation time of the second virtual machine, when a predetermined condition indicating deterioration of the external device is satisfied.

### Supplementary Note 2

A control method for controlling an in-vehicle control device to be installed in a vehicle, the control method including: a generating step of generating a plurality of virtual machines by allocating, for each allocation time, physical resources including a control unit, a storage unit, and a communication unit; and a control step of extending an allocation time of a first virtual machine among the plurality of virtual machines and shortening an allocation time of a second virtual machine among the plurality of virtual machines, when a predetermined condition indicating deterioration of an external device provided outside the in-vehicle control device is satisfied, the first virtual machine being configured to communicate with the external device and execute processing not carriable over to a next cycle, and the second virtual machine being configured to execute processing carriable over to the next cycle.

### Supplementary Note 3

A computer program for controlling an in-vehicle control device to be installed in a vehicle, the computer program causing a computer to execute: a generating step of generating a plurality of virtual machines by allocating, for each allocation time, physical resources including a control unit, a storage unit, and a communication unit; and a control step of extending an allocation time of a first virtual machine among the plurality of virtual machines and shortening an allocation time of a second virtual machine among the plurality of virtual machines, when a predetermined condition indicating deterioration of an external device provided outside the in-vehicle control device is satisfied, the first virtual machine being configured to communicate with the external device and execute processing not carriable over to a next cycle, and the second virtual machine being configured to execute processing carriable over to the next cycle.

### Appendix

Note that at least parts of the above embodiments may be suitably combined with each other. Also, the embodiments disclosed herein are to be considered exemplary in all respects and not restrictive. The scope of the present disclosure is indicated by the claims, and all changes that come within the meaning and range of equivalency of the claims are intended to be embraced therein.

1. An in-vehicle control device to be installed in a vehicle, comprising:
physical resources including a control unit, a storage unit, and a communication unit; and
a management unit configured to generate a plurality of virtual machines by allocating the physical resources for each allocation time,
the plurality of virtual machines including:
a first virtual machine configured to communicate with an external device provided outside the in-vehicle control device and execute processing not carriable over to a next cycle; and
a second virtual machine configured to execute processing carriable over to the next cycle,
the management unit executing a first change control for changing an allocation time of each of the first virtual machine and the second virtual machine, and
the first change control including:
a control for acquiring a processing time of the first virtual machine in a first cycle; and
a control for extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

2. The in-vehicle control device according to claim 1, wherein the management unit executes the first change control, when the number of communication retries to the external device by the first virtual machine increases.

3. The in-vehicle control device according to claim 1,
wherein the management unit, after executing the first change control, further executes a second change control for changing the allocation time of each of the first virtual machine and the second virtual machine, and
the second change control includes:
a control for acquiring a processing time of the first virtual machine in a second cycle after the first cycle; and
a control for shortening the allocation time of the first virtual machine and extending the allocation time of the second virtual machine in a cycle after the second cycle, when a buffer time calculated based on the acquired processing time and the allocation time of the first virtual machine changed in the first change control or a rate of change of the buffer time exceeds a second predetermined value greater than the first predetermined value.

4. The in-vehicle control device according to claim 3, wherein the management unit executes the second change control, when the number of communication retries to the external device by the first virtual machine decreases.

5. The in-vehicle control device according to claim 1,
wherein the management unit further executes a third change control for extending the allocation time of the first virtual machine and shortening the allocation time of the second virtual machine, when a predetermined condition indicating deterioration of the external device is satisfied.

6. The in-vehicle control device according to claim 5,
wherein the storage unit stores a first allocation time and a second allocation time that is longer than the first allocation time, and
the management unit
executes the first change control after the third change control,
in the third change control, sets the allocation time of the first virtual machine to the first allocation time, before the predetermined condition is satisfied, and sets the allocation time of the first virtual machine to the second allocation time, when the predetermined condition is satisfied, and
in the first change control, extends the allocation time of the first virtual machine from the second allocation time.

7. The in-vehicle control device according to claim 6,
wherein the storage unit stores a table in which information relating to the predetermined condition is associated with allocation times of the first virtual machine including the first allocation time and the second allocation time, and
the management unit, in the third change control, extends the allocation time of the first virtual machine with reference to the table, when the predetermined condition is satisfied.

8. The in-vehicle control device according to claim 5,
wherein the predetermined condition includes:
a predetermined time or longer elapsing from a reference timepoint,
the external device operating for a predetermined time or longer from the reference timepoint, or
the vehicle traveling a predetermined distance or more from the reference timepoint, and
the reference timepoint includes:
a timepoint at which use of the external device is started, or
a timepoint at which the allocation time of the first virtual machine is extended.

9. A control method for controlling an in-vehicle control device to be installed in a vehicle, the control method comprising:
a generating step of generating a plurality of virtual machines by allocating, for each allocation time, physical resources including a control unit, a storage unit, and a communication unit; and
a control step of changing an allocation time of each of a first virtual machine and a second virtual machine among the plurality of virtual machines,
the first virtual machine being configured to communicate with an external device provided outside the in-vehicle control device and execute processing not carriable over to a next cycle,
the second virtual machine being configured to execute processing carriable over to the next cycle, and
the control step including:
an acquisition step of acquiring a processing time of the first virtual machine in a first cycle; and
a change step of extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

10. A computer program for controlling an in-vehicle control device to be installed in a vehicle, the computer program causing a computer to execute:
a generating step of generating a plurality of virtual machines by allocating, for each allocation time, physical resources including a control unit, a storage unit, and a communication unit; and
a control step of changing an allocation time of each of a first virtual machine and a second virtual machine among the plurality of virtual machines,
the first virtual machine being configured to communicate with an external device provided outside the in-vehicle control device and execute processing not carriable over to a next cycle,
the second virtual machine being configured to execute processing carriable over to the next cycle, and
the control step including:
an acquisition step of acquiring a processing time of the first virtual machine in a first cycle; and
a change step of extending the allocation time of the first virtual machine and shortening the allocation time of the second virtual machine in a cycle after the first cycle, when a buffer time calculated based on the acquired processing time and the allocation time set for the first virtual machine or a rate of change of the buffer time is lower than a first predetermined value.

11. The in-vehicle control device according to claim 2,
wherein the management unit, after executing the first change control, further executes a second change control for changing the allocation time of each of the first virtual machine and the second virtual machine, and
the second change control includes:
a control for acquiring a processing time of the first virtual machine in a second cycle after the first cycle; and
a control for shortening the allocation time of the first virtual machine and extending the allocation time of the second virtual machine in a cycle after the second cycle, when a buffer time calculated based on the acquired processing time and the allocation time of the first virtual machine changed in the first change control or a rate of change of the buffer time exceeds a second predetermined value greater than the first predetermined value.

12. The in-vehicle control device according to claim 2, wherein the management unit further executes a third change control for extending the allocation time of the first virtual machine and shortening the allocation time of the second virtual machine, when a predetermined condition indicating deterioration of the external device is satisfied.

13. The in-vehicle control device according to claim 3, wherein the management unit further executes a third change control for extending the allocation time of the first virtual machine and shortening the allocation time of the second virtual machine, when a predetermined condition indicating deterioration of the external device is satisfied.

14. The in-vehicle control device according to claim 4, wherein the management unit further executes a third change control for extending the allocation time of the first virtual machine and shortening the allocation time of the second virtual machine, when a predetermined condition indicating deterioration of the external device is satisfied.

15. The in-vehicle control device according to claim 6,
wherein the predetermined condition includes:
a predetermined time or longer elapsing from a reference timepoint,
the external device operating for a predetermined time or longer from the reference timepoint, or
the vehicle traveling a predetermined distance or more from the reference timepoint, and
the reference timepoint includes:
a timepoint at which use of the external device is started, or
a timepoint at which the allocation time of the first virtual machine is extended.

16. The in-vehicle control device according to claim 7,
wherein the predetermined condition includes:
a predetermined time or longer elapsing from a reference timepoint,
the external device operating for a predetermined time or longer from the reference timepoint, or
the vehicle traveling a predetermined distance or more from the reference timepoint, and
the reference timepoint includes:
a timepoint at which use of the external device is started, or
a timepoint at which the allocation time of the first virtual machine is extended.
